(19) United States
(12) Patent Application Publication
(10) Pub. No.: US 2009/0047989 A1
(43) Pub. Date: Feb. 19, 2009

(54) Cellular notebook

(75) Inventors: Joseph Harmon, Fairfax, VA (US); Greg Ratta, Ferney-Voltaire (FR)

Correspondence Address: KILYK & BOWERSOX, P.L.L.C., 3925 CHAIN BRIDGE ROAD, SUITE D401, FAIRFAX, VA, 22030, US

(73) Assignee: Questox Corporation, Fairfax, VA (US)

(21) Appl. No.: 12/228,183

(22) Filed: Aug. 11, 2008

Related U.S. Application Data
(60) Provisional application No. 60/965,045, filed on Aug. 16, 2007.

(51) Int. Cl. H04M 1/00

(52) U.S. Cl. 455/550.1

(57) ABSTRACT

The present teachings relate to a wireless communications, data, and multimedia device that can utilize various service, media, and channels including, for example, cellular radio frequency, wireless hotspot 802.11x radio frequencies, HD radio frequency, and BLUETOOTH® radio frequency, all in an integrated device. The present teachings further provide a Cellular Notebook device featuring a keypad comprising both a QWERTY keyboard and a telephony keypad. The present teachings provide for broadband data service via a primary link using cellular radio frequency data services, and optionally 802.11x hotspot data connections to the Internet. The Cellular Notebook can utilize flash memory, USB, and BLUETOOTH® data and memory storage components only. The Cellular Notebook according to the present teachings can provide the user with network specific-content and serve as an integrated device that empowers the user in an emergency situation like no previously available device.

### CROSS-REFERENCE TO RELATED APPLICATIONS

The present application claims the benefit of earlier filed U.S. Provisional Patent Application No. 60/965,045, filed Aug. 16, 2007, which is incorporated herein in its entirety by reference.

### FIELD

The present teachings relate in general to wireless devices and wireless access to communication services, to data communications, to broadcast radio reception, and to reception of multimedia services.

### BACKGROUND

The digital divide has been defined as the significant segment of the population that has limited or no access to Internet services and communications. To date, the cellular wireless communications and data services industry has focused on hand-held devices designed for convenience, and not general-purpose information devices for wide-ranging access. A device is needed to bridge the digital divide and provide a cost-efficient, widely-available, fully-capable communications appliance that can seamlessly access Web and other services, via both cellular carriers and open access wireless networks. Other problems exist in the wireless information industry.

### SUMMARY

The present teachings relate in one regard to a wireless communication and information device configured to access automatically and transparently access Internet and other media or information services, via cellular network access points including rollover to WiFi, WiMax, or other data networks, upon need or demand. The present teachings overcome various shortcomings in the art, and fill the current digital void by empowering a broad range of consumers with direct access to integrated voice communications, broadcast radio, video, and other media, channels or data services all in one self-contained, notebook-like appliance. While known devices or services have sought to fulfill select issues involved with display and functionality of mobile wireless data services, various embodiments of the present teachings can offer the ergonomics and utility of a notebook user interface in a clamshell or foldable form factor, while providing access to advanced services such as Internet connectivity, voice communications, integrated accessibility functionality, biometric security, GPS location services, and broadcast radio reception.

The present teachings in one regard can employ a full-size graphical interface, full-size QWERTY keyboard, and other ergonomics and functionality resembling a notebook computer, and therefore break the conventional mold and usability limits of a hand-held device. A wireless information device according to the present teachings is referred to herein as a “Cellular Notebook.” The Cellular Notebook, in design and application, is not a notebook computer as presently understood. From a usability standpoint regarding, specifically, the user interface (keyboard, joystick mouse, flat screen, etc.), the device offers standard, well-known computer industry features and user interface devices. The Cellular Notebook is characteristically, however, not a computer, but a mobile, cellular wireless communications, media, and data device that can be integrated in a single, transportable clamshell form-factor.

One problem that the Cellular Notebook solves is the difficulties in the complexity, dependability, and cost of conventional notebook computers. The Cellular Notebook provides, in one regard, an easy-to-use, intuitive, and fully integrated wireless communications, media and data device, whose user interface places comparatively little demand on users, whether novice or experienced. The consumer need only authenticate and begin to immediately use the device to access media, information, or data. There is no need for a user of the Cellular Notebook to “boot-up” or otherwise intensively configure the device, unlike conventional personal computers. In various embodiments, built-in security features can permit even the first-time user to protect their data from theft or corruption, and accessibility measures can be integrated for ease of use as well. The Cellular Notebook requires little more from the user than being conversant with the basic use of a Web browser, or other navigation interface.

In various embodiments, the Cellular Notebook can provide cellular carriers or other access point or network operators with advanced network usage intelligence, on a per-user basis. When a user authenticates to the Cellular Notebook and then connects to a WiFi, WiMax or other wireless data service, the device can provide connection information in the form of a batch log or other file that is captured and transmitted to the carrier. The batch log file can, for example, contain IP address, time and date stamp, bandwidth consumed upstream and downstream, and other information providing heretofore unavailable business intelligence to the carrier, including, for instance, data regarding the extent of use of external or rollover data services that are available to the user outside of the carrier's network. The Cellular Notebook can be used with any cellular carrier, or other wireless access point or network provider. According to various embodiments, the Cellular Notebook and associated network platform can provide for the option of integrating carrier-specific or value-added services. In embodiments, the Cellular Network can be manufactured and sold incorporating carrier-bundled media, with specific packages being installed on the device by individual carriers or providers. In embodiments in which bundled media are provided, the associated software can be configured to channel or encompass proprietary multimedia services of the specific carrier network to which the device is attached. If the user chooses to switch or update the device to another carrier for service, the software integrating the original proprietary multimedia services can be disabled and not available to the device owner. In that case, media for the new carrier can then be installed.

Additionally, the present teachings can provide for proprietary Web service and cellular carrier-specific, multimedia and transaction-service offerings. As the Cellular Notebook can directly send the user to Internet-based Web services from the native user interface, marketing agreements can be extended and integrated into the menu of services accessed via the device, based upon business affiliations. The Cellular Notebook according to the present teachings can thus organize and present a unique combination of service offerings to the consumer, based upon the business affiliations that exist among the retail provider of the device, the cellular carrier, and the Internet Web service provider, or other participants. The Cellular Notebook can offer or facilitate a unique transaction platform that can be used to provide financial transactions to the user via the cellular carrier, without, for instance, the need to provide credit card-specific information to the Internet Web-service provider. In some embodiments, for instance, video or music download or on-demand services can be accessed using the Cellular Notebook, and charges for accessing that media can be automatically billed to the user's associated cellular telephone account. In various embodiments, the user can register for cellular-based, Web-based, or other media, channels, or services, on a subscription or per-use basis.

As an integrated wireless communications device, the Cellular Notebook can deliver a variety of advanced media such as, for example, live broadcast HD radio services, satellite-based music, radio, or other services, video services, social networking services, or others so that the device can serve as an entertainment appliance. In some embodiments, the device can also integrate emergency location or assistance services, such as 911 or other services. Providing the consumer with an integrated, mobile device that can connect them with diverse access points including the Internet, the cellular telephony network, and broadcast radio empowers the user with a wide range of emergency support while traveling, and in other unexpected situations.

Further, the Cellular Notebook can easily be used as a peripheral device to a standard personal computer (PC), to a wired network, or to another computer or information resource. Various embodiments of the present teachings can provide for connectivity, such as Universal Serial Bus or other network connectivity, thereby allowing for data service connections between the Cellular Notebook and a PC, wired network, or other resource. Additionally, in some embodiments the Cellular Notebook can utilize wireless connectivity, for peripheral connectivity to output devices, or to other data appliances or networks. As such, the device can allow for the exchange of data between itself and other mobile phones, PCs, PDAs, printers, digital cameras, digital video cameras, video game consoles, or other devices, networks, or services.

The Cellular Notebook according to the present teachings can in further embodiments allow for the registration of multiple users, which can be on a hierarchical basis with a single primary owner and multiple secondary users. According to various embodiments, the secondary users can for instance be assigned different access rights or privileges.

### BRIEF DESCRIPTION OF THE DRAWINGS

Features of the cellular notebook communications device and associated network platform according to various embodiments of the present teachings will be evident from the following description, taken in conjunction with the accompanying drawings.

FIGS. 1-4 illustrate various external perspectives of the Cellular Notebook, according to various embodiments of the present teachings.

FIG. 5 illustrates a system overview of the Cellular Notebook, according to various embodiments.

FIG. 6 illustrates exemplary hardware components of the Bluetooth® module, WiFi module, HD Radio module, and Cell phone module of the Cellular Notebook, according to various embodiments.

FIG. 7 illustrates hardware components of a Global Positioning System (GPS) module that can be integrated into the Cellular Notebook, according to various embodiments.

FIG. 8 illustrates exemplary hardware components of a cell phone module of the Cellular Notebook, according to various embodiments.

FIG. 9 illustrates exemplary hardware components of an antenna subsystem of the Cellular Notebook, according to various embodiments.

FIG. 10 illustrates exemplary hardware components of an audio module of the Cellular Notebook, according to various embodiments.

FIG. 11 illustrates exemplary hardware components of a Status I/O module of the Cellular Notebook, according to various embodiments.

FIG. 12 illustrates an exemplary fingerprint scanner module of the Cellular Notebook, according to various embodiments.

FIG. 13 illustrates an exemplary screen view of a graphical user interface presented in the Cellular Notebook, according to various embodiments.

FIGS. 14A-14C illustrate a flow chart of a logical flow of communication activities when using the Cellular Notebook, according to various embodiments.

### DETAILED DESCRIPTION

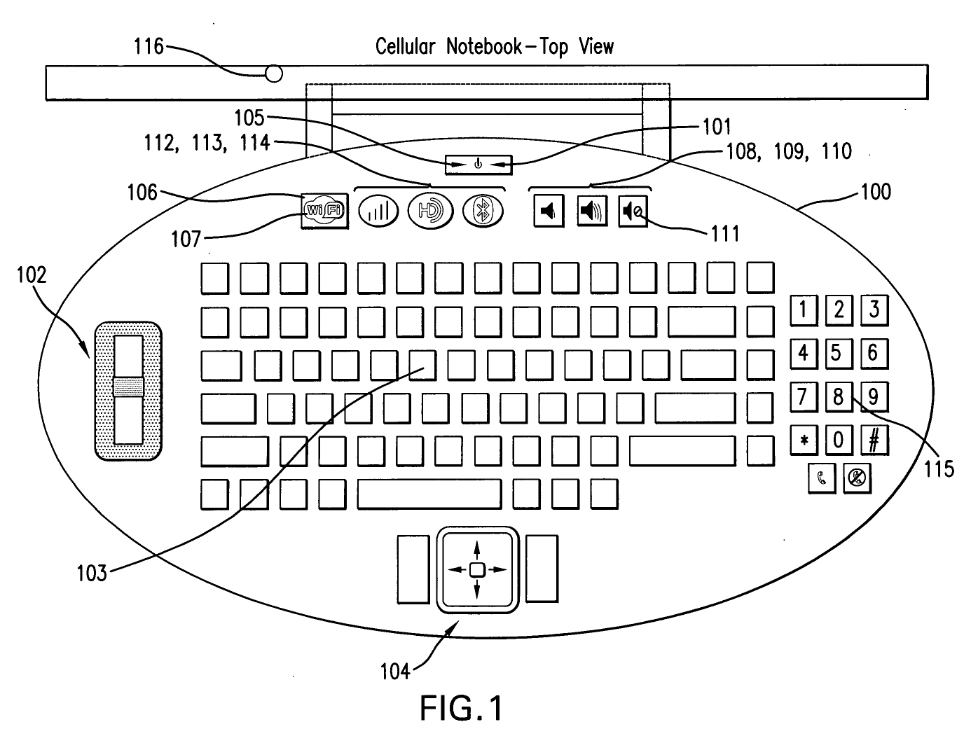

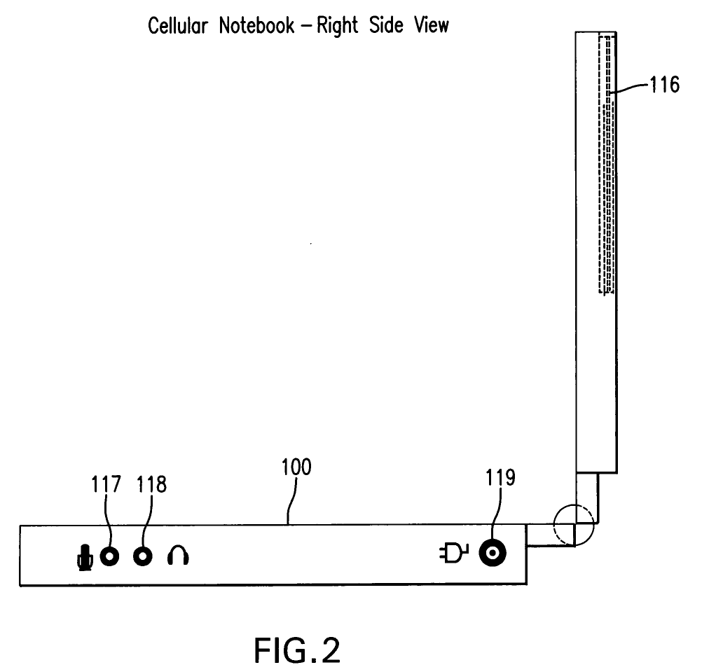

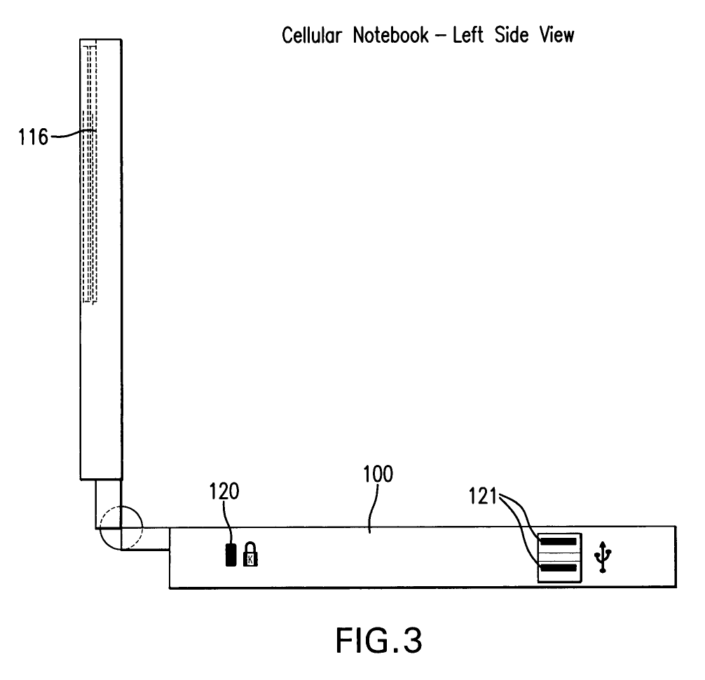

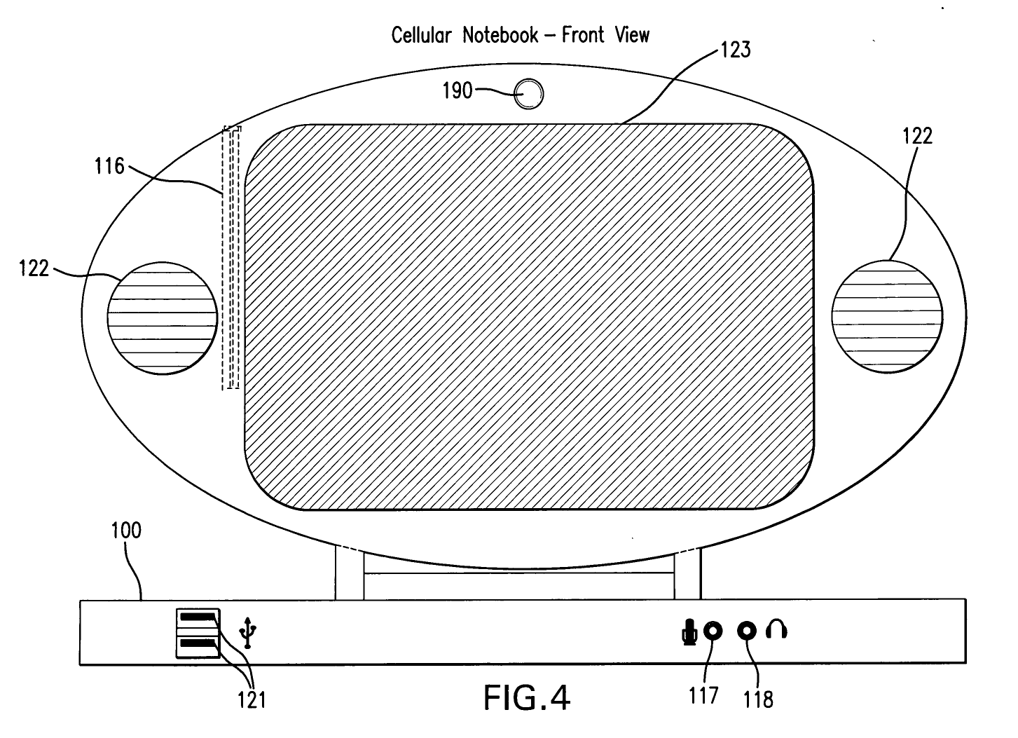

FIGS. 1-4 illustrate various embodiments of a mobile wireless communications device, Cellular Notebook 100. In various embodiments, Cellular Notebook 100 can offer a comparatively streamlined, intuitive interface permitting ready access to a variety of media, services, and channels, for example, via a wireless cellular channel, a mobile wireless data network channel, a wired network channel, or other access point or wireless data network. According to various embodiments, for example, upon opening the lid of Cellular Notebook 100, Cellular Notebook 100 can automatically detect the desired state change, for instance as described below, and display an initial authentication screen on LCD display 123. Cellular Notebook 100 can also illuminate a status LED 105. At this point, the user can be directed by instructions on LCD display 123 to use biometric security user interface 102 to verify or authenticate the user's identity. Upon identification or verification, CPU 200 can direct the display of a startup screen on LCD display 123.

At this point, in various embodiments, LCD display 123 can show the choice of applications, media, channels, or services that are accessible or possible for the user to use. According to various embodiments, user interface mechanisms available for the user to interact with the system can comprise a keyboard 103, and can comprising a pointing device 104. In some embodiments, keyboard 103 can comprise a QWERTY keyboard or other type of keyboard. According to various embodiments, other user interface devices and modes, for example, accessibility features for visually impaired users and hearing-impaired users, can also be used.

Other devices or resources for the user to interact with Cellular Notebook 100 can include: a pushbutton 106 for enabling/disabling connectivity via WiFi, WiMax or other wireless data link, and an indicator 107 of this state; a set of pushbuttons 108, 109, and 110 to raise, lower, and mute, respectively, the sound emanating from speakers 121 and headset 118; an LED 111 to indicate if sound has been muted; a set of LEDs 112, 113, and 114 to indicate that a broadband data connection is active, that HD Radio is on, and that a Bluetooth® device is connected, respectively; a set of pushbuttons that form a keypad 115 and “send” and “end” call buttons. Keypad 115 can comprise a telephony keypad, a QWERTY keyboard, another type of keypad, or a combination thereof. In some embodiments, keypad 115 can comprise both a QWERTY keyboard and a telephony keypad.

Additional features and resources of Cellular Notebook 100 can illustratively include: an antenna 116 for the AM band of an HD Radio module 900, which telescopes inside the upper portion of Cellular Notebook 100; a socket 117 for connecting to an external microphone; a socket 118 for connecting to an external headset; a socket 119 for connecting an external power adapter; a socket 120 for connecting a security cable; a pair of USB sockets 121; and a pair of speakers 122. In some embodiments, Cellular Notebook 100 can comprise a camera 190, for example, a webcam, a video camera, a digital camera, or another type of camera. These listed cameras are only meant to serve as examples, and do not limit the wide variety of cameras that Cellular Notebook 100 can comprise.

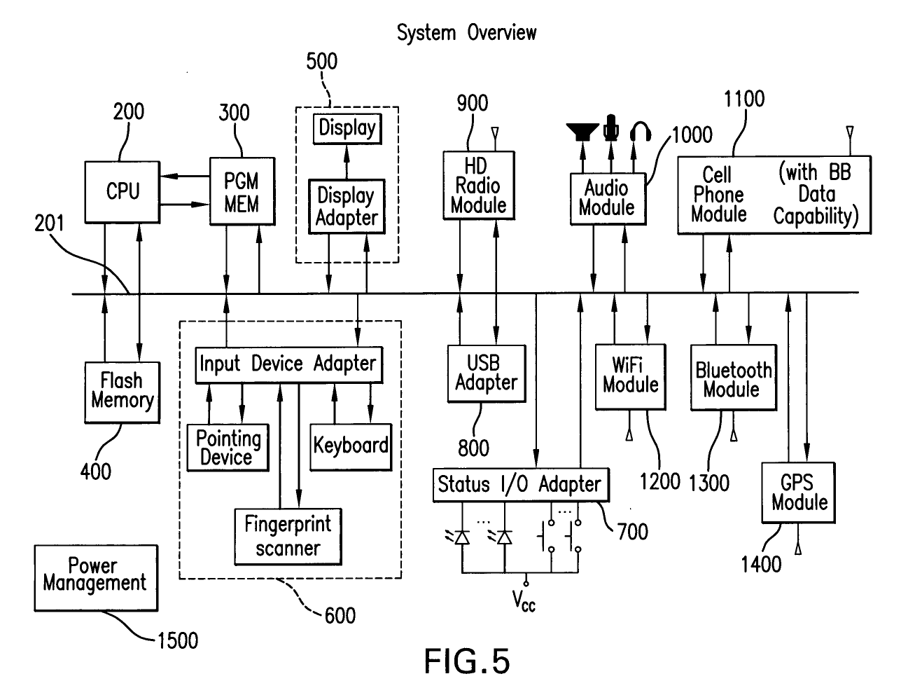

FIG. 5 depicts a system overview of an illustrative set of modules or circuits that can be incorporated in Cellular Notebook 100. An innovative aspect of Cellular Notebook is the integration within a single device of a number of functionalities and resources that existing technology only presents in separate, stand-alone devices. Cellular Notebook 100 can incorporate components, including, for example, a Central Processing Unit (CPU) 200; program memory 300 (PGM MEM); flash memory 400; display and display driver 500; keyboard, pointing device and their input device adapter 600; status input/output adapter 700; and Universal Serial Bus (USB) 800. As will be appreciated, the components can operate as they do in a conventionally known computer. Unlike known computer implementations, in various embodiments, Cellular Notebook 100 can be configured to incorporate and rely upon only flash memory, for local storage. That is, according to various embodiments, Cellular Notebook 100 does not include and does not require drive-based mass-storage media, such as a hard disk drive, a CD ROM reader, Blu-ray™ reader, or DVD reader. The elimination of disk-based mass-storage media, can reduce power consumption, weight, and expense, can increase reliability, and can modify the manner in which a user can install new software, media, or functionality into Cellular Notebook 100. In various embodiments, a hard disk or other disk-based mass storage can, however, be used.

The illustrative set of modules or functions 900 through 1400 can interact as peripheral devices with CPU 200 of Cellular Notebook 100. These functions or resources can include, for example, an HD Radio module 900, which can be configured to broadcast, for example, AM frequency, FM frequency, HD radio, other types of radio frequencies, or a combination thereof. As will be appreciated, CPU 200 can interact with other kinds of radio modules, and is not limited to HD radio. For example, CPU 200 can interact with regular broadcast radio frequencies. In various embodiments, Cellular Notebook 100 can be implemented with a satellite chip 135 that can be configured to receive satellite radio. CPU 200 can interact with: an audio module 1000 that interfaces with the microphone and speakers to receive and emit sound energy and convert it to or from digital coding; a cell phone module 1100 that can include functionality for broadband data communication through a wireless service provider, as well as conventional cellular telephone capability including dialed calls; a WiFi module 1200 that can be configured to enable broadband communication through WiFi hotspots; a Bluetooth® module 1300 for interaction with external devices such as a wireless headset; and a Global Positioning System (GPS) module 1400 to enable precise location of the Cellular Notebook 100 via GPS signaling. As will be appreciated, Bluetooth® module 1300 can be a close range wireless communication module configured to allow close range wireless communications, for example, within 100 feet. According to various embodiments, broadband data communications that have originated via the data functionality of the cellular data communications (e.g., EDGE service) of cell phone module 1100, can be rolled over or redirected to enable communications via WiFi module 1200 through a WiFi hotspot. In some embodiments, other numbers, types, and configurations of modules or functions can be used.

In various embodiments, Central Processing Unit (CPU) 200 can provide overall control of the operation of Cellular Notebook 100. CPU 200 can be implemented by a commercial microprocessor, such as the Quad-Core Intel Xeon™ processor E5345, or other general-purpose microprocessor, by a special-purpose processor such as a digital signal processor, or other processor or programmable controller. The particular choice of processor is not determinative, although its choice will determine the amount of original device driver programming that is necessary, as well as the availability of a working operating system or components of an operating system, including an open source one such as Linux. Desirable features exemplified in the E5345 include: enhanced energy-efficiency to balance processing capabilities within power and space constraints; greater isolation and security between different applications and operating systems for added protection against corruption, each core having access to full on-die L2 cache; management of run-time power consumption of all execution cores; and diverse operating systems and applications that can be consolidated quickly and easily on this processor, or others.

Program memory 300 and flash memory 400 can be fabricated from the same storage technology, for example, the commercially available Intel 8913. These memory components are represented separately in this illustration to highlight certain aspects of program memory 300, where the operating system, application programs, and service data are stored. This portion of the memory can be protected from modification, except through interaction with a server of the cellular carrier. The Intel 8913 device is a 64 Mbit Serial Flash memory with a common SPI interface. The SPI interface consists of 8 pins. Six of these pins are signals; the other two are Vcc and ground. The 8913 contains eight 8-Kbyte parameter blocks and 127 64-Kbyte main memory sectors. The eight 8-Kbyte parameter blocks can be treated as one 64-Kbyte main memory sector. The 8913 includes security features, including two 8-byte, thirty 16-byte, and one 10-byte individually-lockable OTP Protection Registers that can support multiple uses, including unique flash device identification. An array of 20 8913 devices would provide, for instance, 160 Mbytes of storage capacity. Other types, quantities and configurations of program memory 300 can be used.

According to various embodiments, the display module is comprised of LCD display 123 and a display adapter. The MC54/74HC164A part, which is an 8-bit, serial-input to parallel-output shift register, can be used to implement a display adapter to drive LCD display 123. When driven by a microcontroller such as an Intel 8051, this device can form the display adapter. According to various embodiments, it can be desirable that LCD display 123 be at least 1024×768 pixels (XVGA) in native mode. Other screen display types and resolutions can be used.

According to various embodiments, power and environmental management 1500 can be a useful capability for extending the time that a user can use Cellular Notebook 100 between battery charges. Various known hardware and software-based techniques can be incorporated that turn off or switch various internal devices to a sleep or hibernation mode, to conserve battery power and extend the life of semiconductor devices. According to various embodiments, more than one battery can be provided in Cellular Notebook 100, with one battery devoted solely to the cell phone module 1100 so that the cellular voice, text messaging, or other cellular functions or resources can continue even if all other functions are turned off, due, for instance, to low battery power in the remaining battery or batteries. Temperature management can also be implemented by means similar to power management. Temperature management can be enhanced through the use of a cooling fan that is selectively turned on and off, to keep the internal temperature of Cellular Notebook 100 within the specified operating temperature range of the component parts.

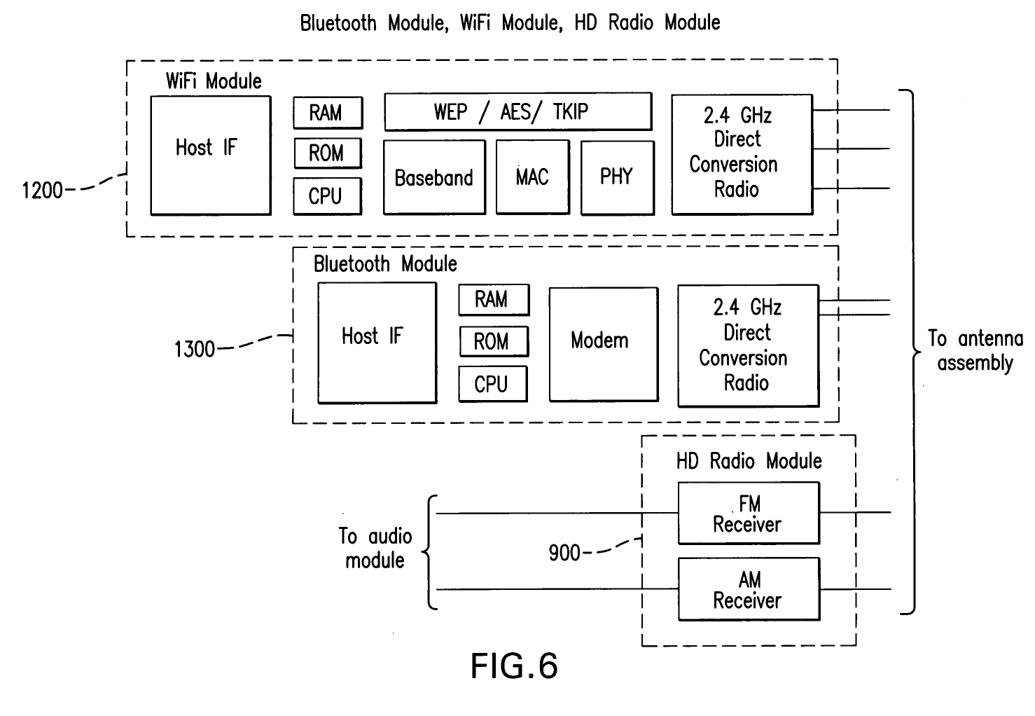

FIG. 6 illustrates functional elements of an HD Radio module 900, WiFi module 1200, and Bluetooth® module 1300, that can be incorporated into Cellular Notebook 100 according to various embodiments. In each of these modules, the digital coding can be extracted from the radio waves upon reception, and, in the case of all modules but HD Radio module 900, the digital coding is modulated with the appropriate carrier frequency for transmission. In various embodiments, all these functions can be implemented in multiple chips, or on a single chip, for instance, utilizing CMOS technology. Current technology, for example, the commercially available Broadcom BCM4325G chip, integrates IEEE 802.11b/g (MAC/Baseband/Radio), Bluetooth® 2.1+enhanced data rate (EDR), and FM receiver functionality in this manner. Such chips can be designed to address the needs of highly mobile devices that require minimal power consumption and reliable operation. The present teachings contemplate that future CMOS or other chips that integrate other communications functions and modules, for example, that integrate an HD Radio receiver in place of the FM receiver, can be incorporated into the resources of Cellular Notebook 100.

External to the one or more communications chips are crystal oscillators, reference clocking and power supplies. The specific chips and settings are dependent upon the custom chip design choices described above. On-chip buffers can interface to flash memory 400 via system bus 201. In this manner, data can be exchanged between the external devices/networks connected via WiFi module 1200 or Bluetooth® module 1300, and CPU 200.

FIG. 6 illustrates an implementation incorporating communications resources, including a WiFi module 1200 compatible with current IEEE Standards 802.11b and 802.11g. In some embodiments, compatibility with and incorporation of emerging and future communications interfaces and standards, such as 802.11n, is provided by the present teachings. According to various embodiments, the implementing chip or chips implement the power save capabilities documented in IEEE Standard 802.11e, to save battery power and fine-tune power consumption. Similarly, the implementing chip or chips can be compatible with IEEE Standard 802.11i that specifies security mechanisms for wireless networks, as well as with IEEE Standard 802.1x to provide port-based Network Access Control. According to various embodiments, the implementing chip or chips can implement IEEE Standard 802.15.2, to reduce interference between WiFi and Bluetooth® channels.

In various embodiments, Bluetooth® module 1300 can implement the current Bluetooth® Core Specification Version 2.1+enhanced data rate (EDR) and supports extended synchronous connections (eSCO) for enhanced voice quality by allowing for retransmission of dropped packets. Future Bluetooth® specifications are provided by, and can be incorporated in, the present teachings.

In terms of media delivery, Cellular Notebook 100 can incorporate an HD Radio module 900 or other forms of broadcast radio, such as, satellite radio. “HD Radio™” is a brand name of iBiquity Digital Corporation for techniques for digital transmission of AM and FM radio stations. The known HD Radio system allows stations to broadcast audio and a variety of text-based services, as well as more FM channels, without changing to new frequency bands. Cellular Notebook 100 can, in various embodiments, incorporate an HD Radio module 900 as one means of increasing the accessibility of the digital world to hearing- and sight-impaired individuals. According to various embodiments, text-based services enabled by the HD Radio system can include news and emergency announcements that the can be displayed appropriately for hearing- and sight-impaired individuals on Cellular Notebook 100.

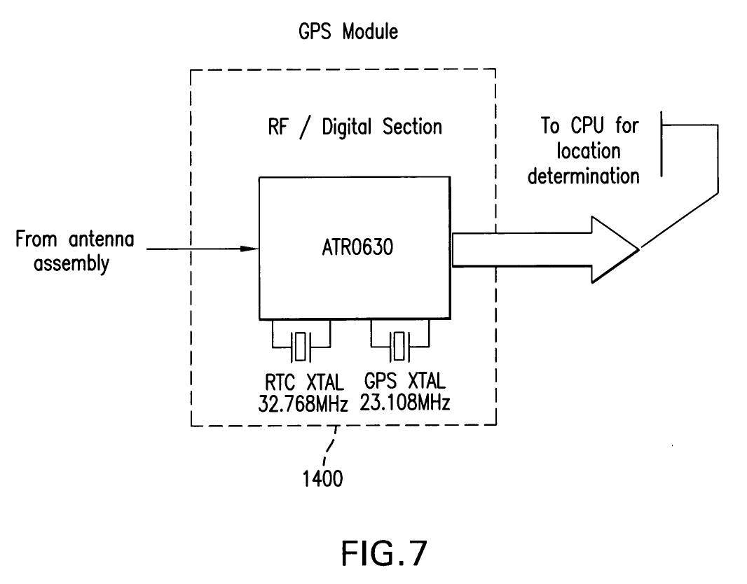

FIG. 7 illustrates certain details of hardware components of GPS module 1400, according to various embodiments. The illustrative implementation is based on the commercially available Amtel ATR0630 chip, which provides fast time-to-first fix, high sensitivity, fast position tracking, and high immunity to jamming. This chip works in concert with external crystals for clocking and setting the GPS carrier frequency. In some embodiments, GPS module 1400 interconnects to a front end section of the antenna assembly. The on-chip buffers can interface to flash memory 400 via system bus 201. In this manner, GPS location data can be presented to CPU 200 and cell phone module 1100 to deliver location-enabled services, and comport with regulatory requirements related to emergency services and to the Communications Assistance for Law Enforcement Act of 1994 (CALEA), Pub. L. No. 103-414, 108 Stat. 4279.

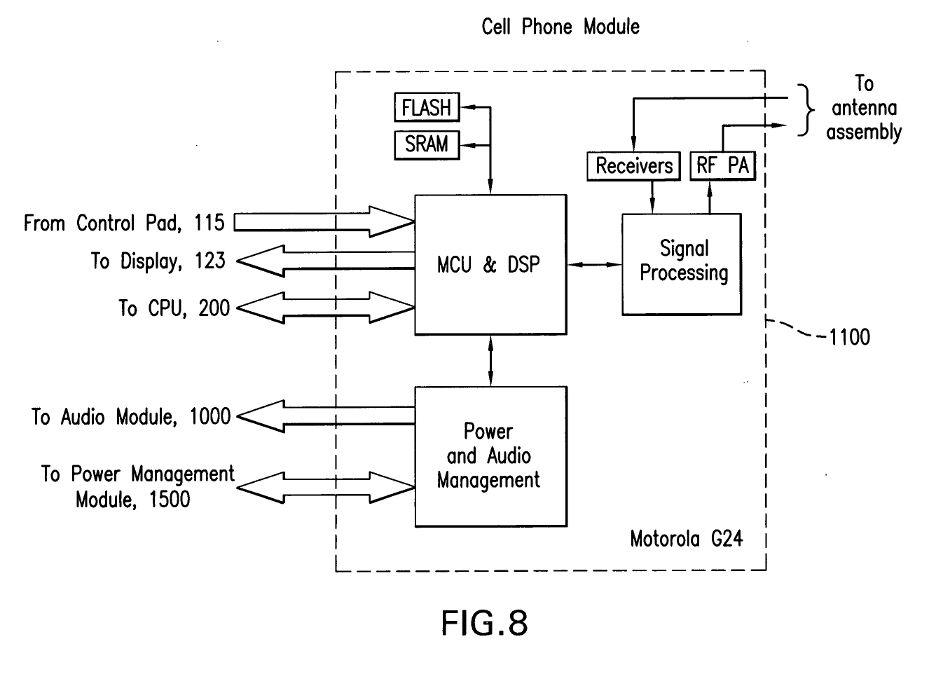

FIG. 8 depicts a cell phone module 1100 illustratively based upon a commercially available Motorola G24 module to provide high-speed, quad band GSM/GPRS/EDGE functionality. In various embodiments, any other cell phone chipset can be used that provides voice, broadband data, and multimedia content transfer. The G24 is a GSM OEM module similar to a condensed cellular phone core. The module is meant to be integrated into a communication system to transfer voice or data information over a cellular network. The G24 supports GSM/GPRS and EDGE technology, and also contains a Java engine. A MIDlet application operates the G24 platform's major functionalities, including circuit switched data and voice calls, IP network connections, SMS/MMS, GSM/GPRS network status, serial connectivity, SIM card, phonebook, file system, record management, low-power mode, airplane mode, and real-time clock, among others.

Cell phone module 1100 can be interconnected with the antenna assembly as discussed below, and the choice of a specific chipset in cell phone module 1100 can impact the design details of that assembly. A keypad 115 can provide input signals to cell phone module 1100 and LCD display 123 receives information from cell phone module 1100 to guide the user. Cell phone module 1100 can interact with CPU 200 to share status information, and interact with power management module 1500 to adjust the mode of operation, if necessary to conserve power. Cell phone module 1100 can also connect with audio module 1000 to enable signal transfer with microphone jack 118, speakers 122, and headphone jack 117.

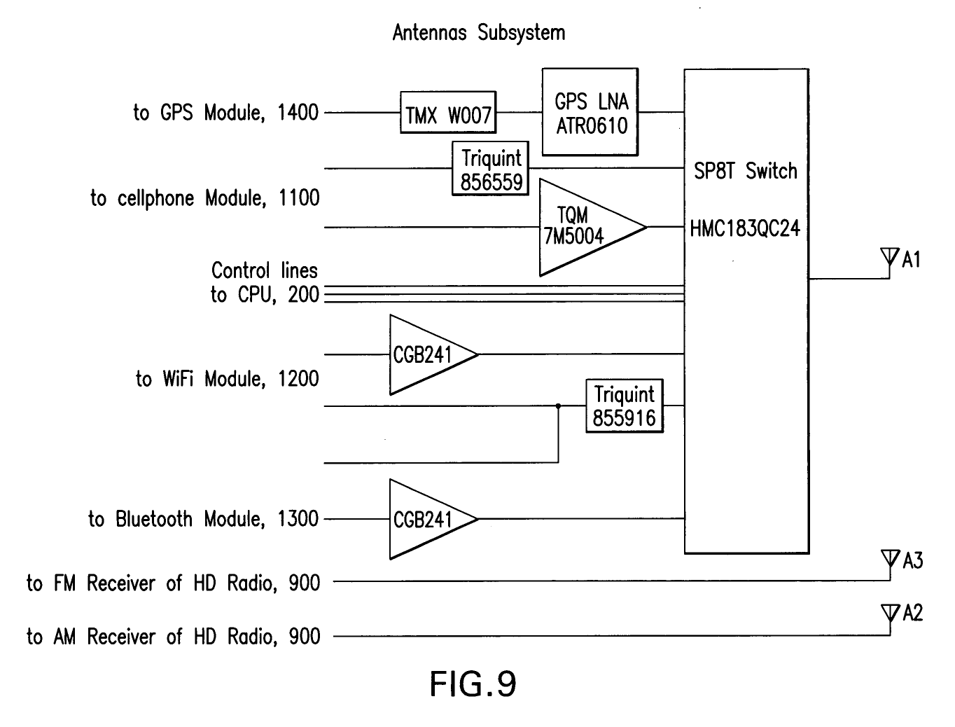

FIG. 9 illustrates certain details of an antenna assembly, according to various embodiments. In some embodiments, separate Front End Sections can be used for each radio to filter the spectrum to the correct portion, and amplify the signal to a suitable level. In some cases, the custom chips discussed above can include some of this functionality. Therefore, the specific design can be dependent upon a selected custom chip design. As understood by persons skilled in the art, there is a need for a Low Noise Amplifier (LNA) and bandpass filter between the antenna and the radio signal detection stage. In some embodiments, the commercially available HMC183QS24 chip can be incorporated in the antenna assembly. That part is a non-reflective, Single Pole 8-throw switch providing wideband operation from DC to 3 GHz, with an integrated 3:8 decoder on the switch requiring 3 control lines, and a positive bias to select each path. This switch, or other implementing parts, can allow the various radios incorporated in Cellular Notebook 100 to share a common antenna.

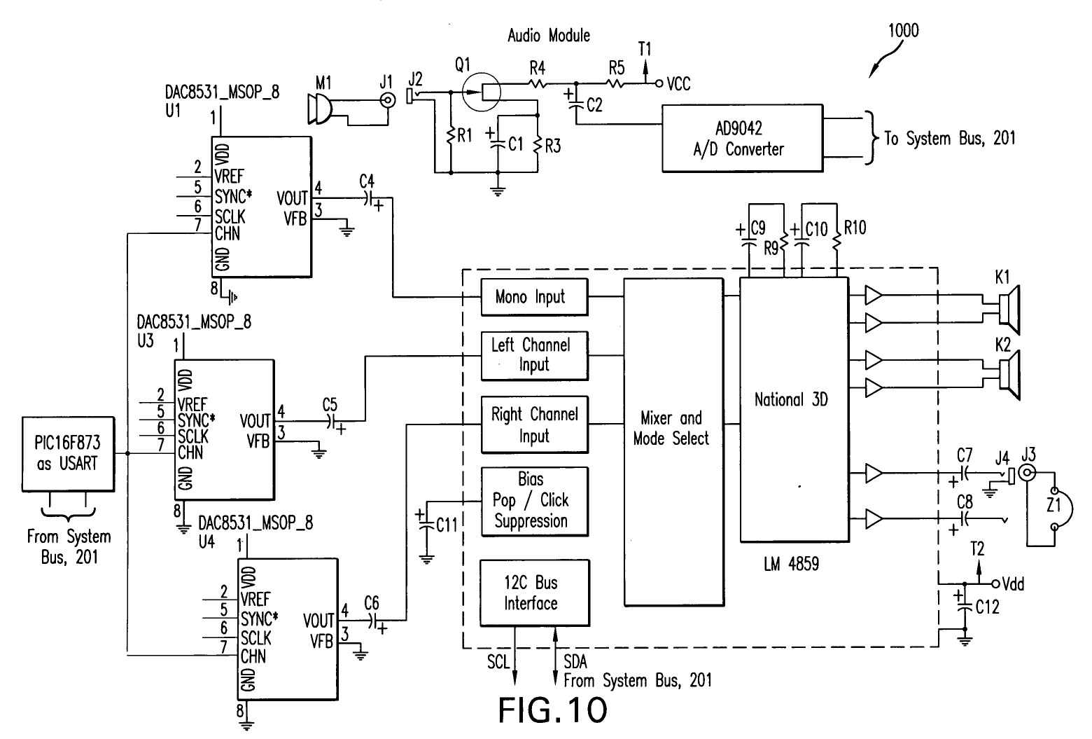

As illustrated in FIG. 10, an Audio Module 1000 can be incorporated that provides amplification of the signals that drive speakers 122 or headphone 118 or that come from microphone jack 117, HD Radio module 900, CPU 200, or cell phone module 1100. If a microphone is plugged into jack 117, a pre-amplifier, shown in FIG. 10 to be comprised of a single MOSFET, can bring the analog signal to a level sufficient to drive the amplifiers. An Analog-to-Digital converter, shown in the figure as a commercially available AD9042, can transform that signal to a digital form which is sent to CPU 200 or cell phone module 1100 via system bus 201, for transmission. A digital representation of sounds from programs operating on CPU 200, from cell phone module 1100, from microphone jack 117, or from the AM portion of HD Radio module 900 can be converted to analog form via a Digital-to-Analog converter (DAC), shown in the figure as a commercially available DAC8531 chip, which is driven and selected through a USART function that is shown in the figure implemented as a commercially available PIC16F873 microcontroller programmed to perform USART functions. Similarly, the left and right channel output of the FM portion of HD Radio module 900 is driven by the USART function through a DAC for each channel. All of these audio signals can be delivered to an audio power amplifier, such as the commercially available National Semiconductor LM4859 chip shown in the figure, which can deliver the sounds to system speakers 122, or to headset plugged into jack 118.

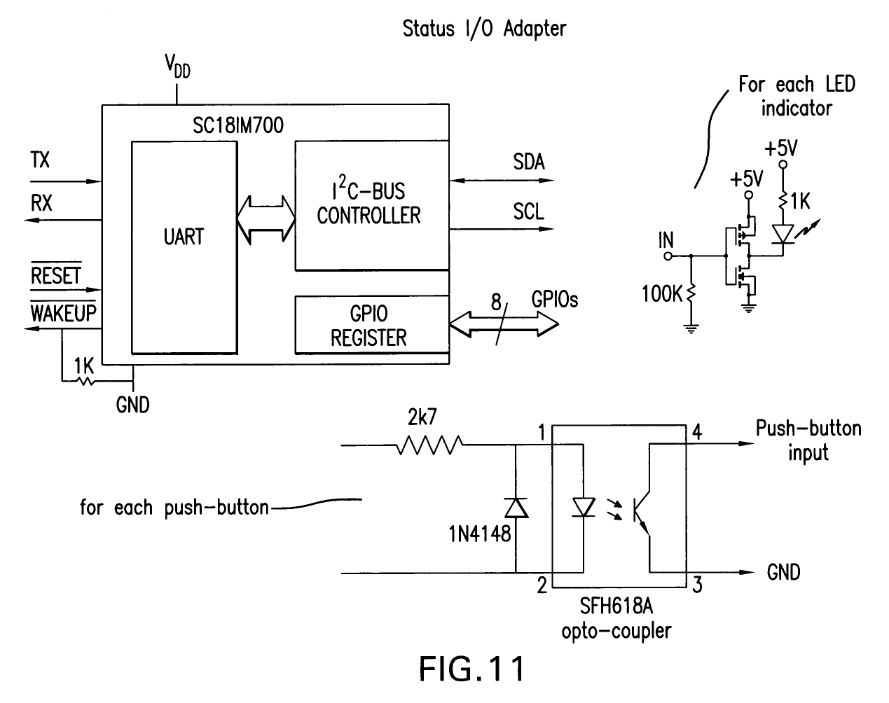

FIG. 11 illustrates status I/O module 700, according to various embodiments. This module is responsible for control of display LEDs and for responding to push buttons activated on Cellular Notebook 100. This module can comprise, as shown, a commercially available Philips SC18IM700 Master I²C-bus controller with UART interface. The SC18IM700 part is designed to serve as an interface between the standard UART port of a microcontroller or microprocessor and the serial I²C-bus. This allows the microcontroller or microprocessor to communicate directly with other I²C-bus devices. The SC18IM700 can operate as an I²C-bus master. The SC18IM700 or other implementing part can control all the I²C-bus specific sequences, protocol, arbitration, and timing. The UART can communicate with CPU 200 through the TX and RX pins. The serial data format for the SC18IM700 is fixed: one start bit, 8 data bits, and one stop bit. CPU 200 can issue an input port read command by sending an I character. This command can enable the CPU to quickly read any GPIO pins programmed as input, without having to read the SC18IM700 internal IOState register. Similarly, CPU 200 can issue an output port write command by sending an O character followed by the data to be written to the output port. This command can enable the host to quickly set any GPIO pins programmed as output, without having to write to the SC18IM700 internal IOState register. Each push-button and each display LED is connected to a particular GPIO pin of the SC18IM700. Debouncing circuitry can be used in the connection of push-buttons, illustrated in FIG. 11 by the use of a commercially available SFH618A opto-coupler.

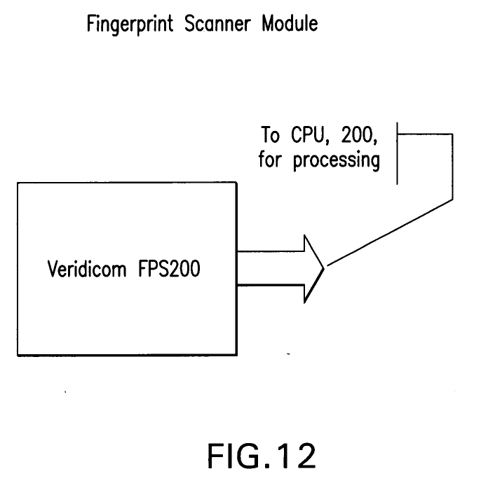

FIG. 12 illustrates an implementation of a fingerprint scanner used as an authentication device for Cellular Notebook 100, through the illustrative use of a commercially available Veridicom FPS200 chip. This solid-state fingerprint sensor is a direct contact fingerprint acquisition device designed for embedded devices, and is a low power, capacitive sensor. The FPS200 sensor array has 256 columns and 300 rows of capacitive sensor plates. An automatic finger detection capability can, when the user places a finger on the biometric security user interface 102, “wake up” the CPU, saving power. An integrated 8-bit analog to digital converter in biometric security user interface 102 can reduce power consumption. Manufacturer specifications indicate that the chip provides fingerprint images at a resolution at 500 dpi from all types of skin, dry to moist, in a wide range of climactic conditions including hot and humid. A standard 8-bit microprocessor bus interface can be used to connect to CPU 200 at an image rate of 30 frames per second, or at other rates, allowing for near-instantaneous image capture and matching. Biometric security user interface 102 can be configured with driver software for standard operating systems such as MICROSOFT WINDOWS™ operating systems, or LINUX operating systems, for which open source drives can be obtained from SOURCEFORGET.NET, or other sources.

In various embodiments, deaf, hearing-impaired, and speech-impaired users can use a “real time text” capability of Cellular Notebook 100 to communicate with others. Real-time text is an alternative to voice telephony, whereas message-based systems such as SMS, MMS or email are non-conversational, supplemental communication systems. Instant Messaging channels lie somewhere in between. Hearing people can use a variety of communication systems, both conversational (voice telephony, IRC, video conferencing, and the like) as well as non-conversational ones (SMS, email, message boards, and the like).

Channels or methods used to communicate can depend on the context, as well as on the abilities and preferences of the user. Real time text telephony offers equivalent features in terms of conversationality for deaf, hearing-impaired and speech-impaired users as voice does to hearing people. This is because real-time text telephony offers a character-by-character based interaction.

So, everything that is typed will appear immediately on the screen at the other end, and vice versa. This can be especially helpful when making relay calls. Relay calls cannot be made via message based systems such as SMS or email. Even Instant Messaging can be undesirable due to high latencies and delays as a result of line buffering the text.

Deaf or hearing-impaired people have communications needs that extend to the rest of their community, whether deaf or not. In fact, the ability to communicate continuously and effectively is extremely important if one is to be a fully enabled citizen in the Information Society, that is: in employment; in education; in social life; in entertainment; and in other contexts. To enable text telephony users to communicate with voice users, there exist relay services, offered by Sprint and MCI in the USA, and similar services in other countries, as well. Current text relay services use human operators that read all the text that the deaf person types to the voice user, and types back to the deaf user what the hearing party says. The usability of these relay services decreases rapidly if the interactivity diminishes. Cellular Notebook 100 enables mobile access to this style of communication.

IETF RFC 4103, “Real-time Transport Protocol (RTP) Payload Type for Text Conversation” describes how to carry real-time text conversation session contents in RTP packets. Text conversation session contents are specified, for instance, in ITU-T Recommendation T.140, “Protocol for Multimedia Application Text Conversation and Addendum 1.” There is an open source reference implementation of the real time text presentation protocol ITU-T T.140 transmitted in an RTP session as specified in IETF RFC4103 within a SIP-based session control environment. That implementation is divided into three parts:
1) a reference implementation for RTP Payload Type for Text Conversation (RFC 4103)—http://sourceforge.net/projects/rtp-text-t140/
2) an implementation of the text presentation routines described in ITU-T T.140—http://sourceforge.net/projects/t140-pres/
3) a SIP-standards-compliant soft phone using text and voice with accessibility features—http://sourceforge.net/projects/tipcon1/.

Screen readers are a form of assistive technology (AT) potentially useful to people who are blind, visually impaired, or learning disabled. A screen reader is a software application that attempts to identify and interpret what is being displayed on the screen. This interpretation is then represented to the user with text-to-speech, sound icons, or a Braille output. When used in conjunction with an external Braille reader, or a program to audibly produce the sounds of the text for presentation on speakers 122 or headphone jack 117, Cellular Notebook 100 can be used by the blind or vision-impaired with little or no difference in functionality or usability.

In some embodiments, an integrated or pre-loaded screen reader can be implemented using commercially or publicly available software resources. The open source Linux GNOME desktop environment, for example, is packaged with two screen readers—GNOPERNICUS and ORCA. There are also stand-alone open source screen readers, such as the LINUX SCREEN READER FOR GNOME and NONVISUAL DESKTOP ACCESS FOR WINDOWS. There are also screen readers sold as separate commercial products, for example JAWS™ from Freedom Scientific, WINDOW-EYES™ from GW Micro, and HAL™ from Dolphin Computer Access.

Since HD Radio technology provides the possibility for multiple digital channels within the current AM and FM frequency bands, it is possible that some stations will use one of the text channels to transmit text versions of its news programs and descriptive text of other programs. Coupled with the accessibility features described herein, a wider audience can be reached by Cellular Notebook 100 than by conventional information devices. This increases the advertising value that can be sold by station operators and this can enable visually-impaired or hearing-impaired individuals to receive services such as emergency announcements in real-time, without dependence upon others.

According to various embodiments, Cellular Notebook 100 can be provided with a USB adapter 800 that can be implemented based upon the commercially available Philips ISP1362 or TRANSDIMENSION TD242LP chips, which implement the “On-the-Go (OTG) Supplement” to the USB specification. This capability allows the USB port to be used alternately as a slave or master, which adds flexibility to the manner in which Cellular Notebook 100 interacts with an external device. The external device or devices to which Cellular Notebook 100 can connect can include, for example, digital cameras, cellular telephones, personal digital assistants, music or video-enabled players, or a traditional personal computer. In some embodiments, connectivity to such devices can require that USB connector 121 be a mini A/B connector allowing a mini A or mini B connector to plug into that receptacle.

The choice of embedded operating system, components of an operating system, or other control software for Cellular Notebook 100 can depend on implementation. According to various embodiments, a complete operating system can be installed. In various embodiments, a streamlined or reduced version of an operating system, or components of an operating system, can be installed. In some embodiments, the selection of an open source operating system like Linux can contribute to a reduced total system cost. In some embodiments, no operating system is installed. Known or existing device drivers can be used for the various hardware components included in Cellular Notebook 100 under different operating systems, if used.

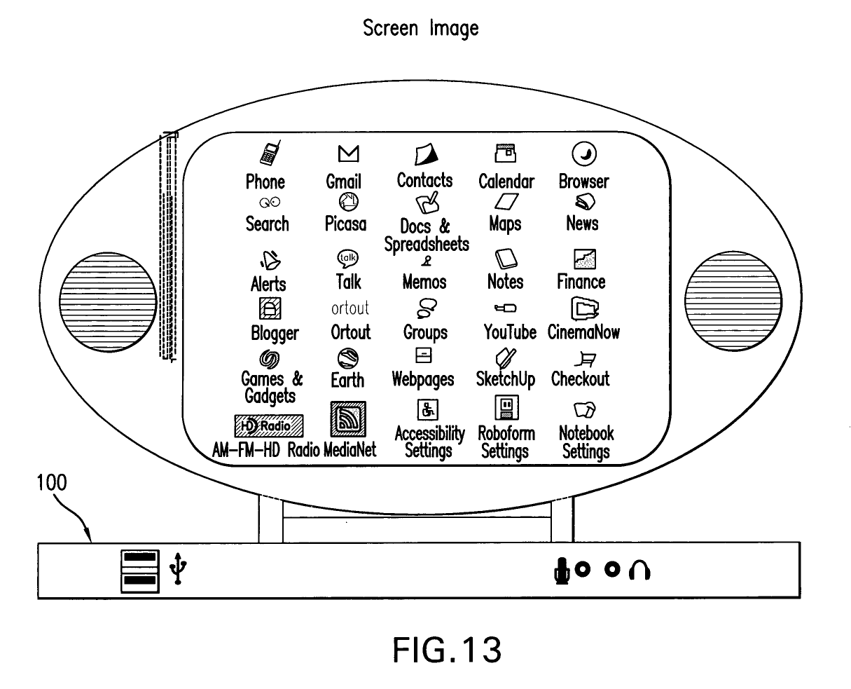

According to various embodiments, Cellular Notebook 100 can be configured for the automatic provisioning of software to individual machines, through downloading or harvesting of Web-based applications. In some embodiments, it is therefore only necessary to have minimal software installed beyond the embedded operating system or other control software, because Cellular Notebook 100 can harvest and configure Web applications or other software resources when required, for example, on an automatic basis. According to various embodiments, Web-based applications, applets, or other resources available to the user of Cellular Notebook 100 can be programmed or provisioned from the cellular network or Internet using, for example, application service provider (ASP™) code, COLDFUSION™ code, PERL code, JAVA™ Script, XML, or other executable or transmissable codes, platforms, scripts, or formats. FIG. 13 illustrates a representative start screen that includes a collection of icons representing each application that is available to the user, whether locally installed or downloadable as a Web-based application.

According to various embodiments, upon opening the lid of Cellular Notebook 100, a micro-switch 101 can close a circuit that is detected by Status I/O module 700 which identifies this state to CPU 200 which, in turn, illuminates an LED to provide a status indication to the user. In some embodiments, because Cellular Notebook 100 can be configured to use only flash memory, all local or installed programs or media can be made immediately available to the user.

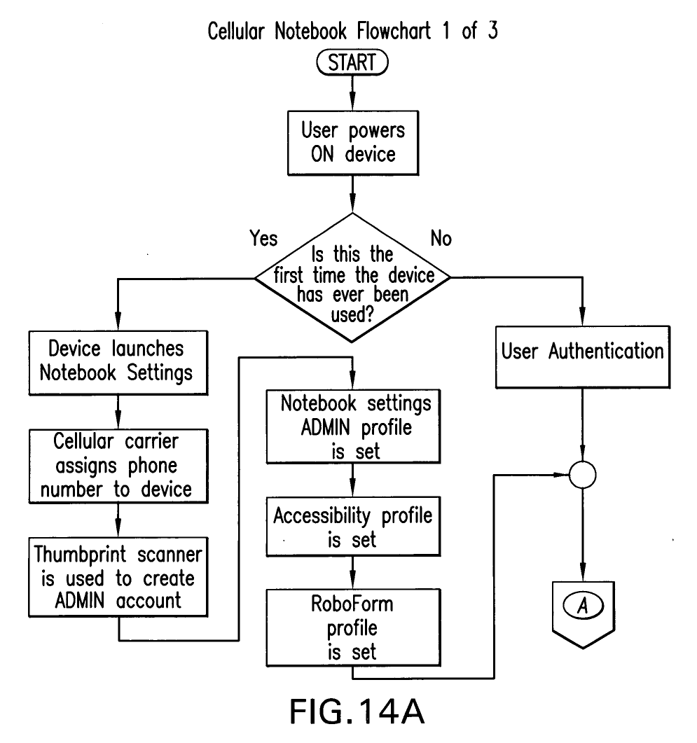

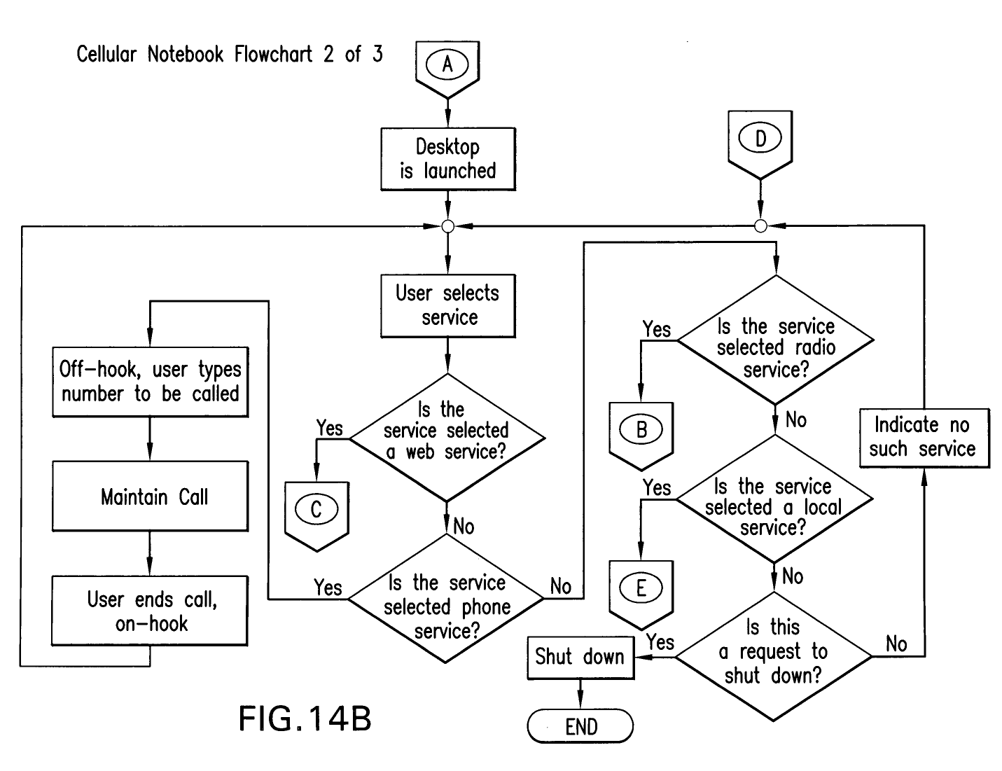

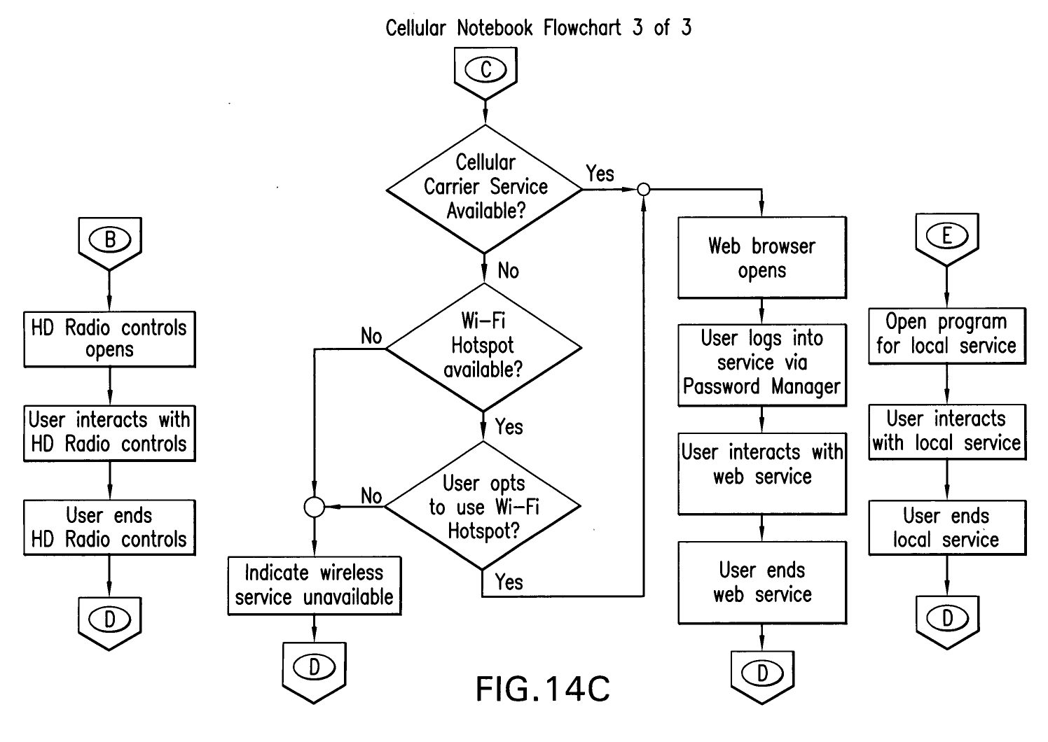

FIG. 14A illustrates a start-up process for Cellular Notebook 100, according to various embodiments. Cellular Notebook 100 first checks if the notebook has been registered with the cellular carrier. If this is an initial use (unregistered), or the first time after a system reset, the user can enter the password and the cell phone address that the cellular carrier assigned to the user when Cellular Notebook 100 was purchased, to be authenticated by the cellular carrier's network. Once authenticated, Cellular Notebook 100 can display instructions for the primary user to associate his or her fingerprint with this account. Once an image of the fingerprint is captured by biometric security user interface 102, it can be stored in an encrypted format in a protected area of flash memory 400 and the association of the fingerprint image with the identity and password of the user can be tracked by a Password Manager, such as the commercially available ROBOFORM™, which is embedded in program memory 300. At this point, Cellular Notebook 100 can present the user with the opportunity to set other preferences, such as desired accessibility features. Once the preferences are set, Cellular Notebook 100 can be launched, that is, can enter a state ready to serve the user's needs. Cellular Notebook 100 in this state can display a startup screen similar to the one shown in FIG. 13, or other screens or interfaces.

FIG. 14B illustrates a flow of system use, once Cellular Notebook 100 is launched. The user can select a desired service, media, or channel, and Cellular Notebook 100 can check if the selected service, media, or channel is Web-based. If the selected service, media, or channel is a Web-based service, processes shown in FIG. 14C can be initiated. If the selection is not Web-based, Cellular Notebook 100 can check if the selected service is a type of cell phone service. If the selected service is a type of cell phone service, Cellular Notebook 100 can receive a set of “dialed digits” from the user, and initiate a cellular call. Cellular Notebook 100 can use known techniques to establish, maintain, and release the call, once the user presses the “talk,” “end” or other corresponding buttons or buttons. If the selected service is not a cell phone service, Cellular Notebook 100 can check if the selected service is an HD Radio service. If the selected service is an HD Radio service, then processes shown in FIG. 14C can be initiated. If the selected service is not an HD Radio service, Cellular Notebook 100 can check if the selected service is a local service. Examples of local services include, for example, administration of settings or viewing photos uploaded from a digital camera. If the selected service is a local service, then processes shown in FIG. 14C can be initiated. If the selected service is not a local service, then Cellular Notebook 100 can check if the user is attempting to shut down Cellular Notebook 100, in which case Cellular Notebook 100 can save any necessary data, software, or service states, and proceed to shut down. If the user is not attempting to shut down Cellular Notebook 100, then the request can be determined to be for an unsupported service. In that case, an error message can be displayed to the user, and Cellular Notebook 100 can await further service selection by the user.

FIG. 14C shows, beginning with label “C”, that if the selected service, media, or channel is Web-based, then cell phone module 1100 can check whether a connection is possible via the user's associated cellular carrier. If a cellular connection cannot be established, then WiFi module 1200 can check if any WiFi networks can be detected. If a WiFi network or other in-range network is detected, the user can be presented with a choice to connect to one of these networks. If the user declines to connect to any of these networks or if there are no networks detected, Cellular Notebook 100 can await further service selection by the user after first notifying the user that there is no wireless data service available at that time and location. If a connection is possible via either cellular service or WiFi service, the connection can be made and the Web browser program can be launched. Should there be a need for user authentication, the password management program can be invoked, for example, in conjunction with biometric security user interface 102. When the user is finished with the Web-based service, he or she can close the Web browser program and Cellular Notebook 100 can await further service selection by the user.

FIG. 14C illustrates, beginning with label “E,” that if the selected service is local to, or loaded or stored in, Cellular Notebook 100, then CPU 200 can open an associated local program or other resource to execute that service. When the user is finished with the local service, he or she can close the program and Cellular Notebook 100 can await further service selection by the user.

FIG. 14C illustrates, beginning with label “B,” that if the selected service is HD Radio, Cellular Notebook 100 can display a control screen for HD Radio and can illuminate a status LED 113. The user can interact with the control screen via pointing device 104 and/or keyboard 103, or other interface device. After the user is finished setting up the desired HD Radio operation, he or she can close the control screen and Cellular Notebook 100 can await further service selection by the user.

The above discussion and the related figures have been organized to ease understanding of various aspects of the logic of the software and its operation and relationship to the various hardware components of Cellular Notebook 100. According to various embodiments, the series of decision blocks can be implemented by a single “case” decision in which CPU 200 waits for user input that identifies the particular case and related service, media, or channel to be followed or executed. In various embodiments, this approach can enable additional cases that particular cellular carriers may choose to activate, within the set of Cellular Notebook devices that they register with their networks. For example, some carriers may choose to allow the ability to start Web-based services directly via WiFi, WiMax, or other wireless data access. This flexibility allows cellular carriers to offer new and unique combinations or packages of services, media, and channels to attract and retain customers. According to various embodiments, a cellular carrier can choose to offer a variety of tiers or levels of services, media, or channels, and can, for instance, offer upgrade paths within those offerings. Such flexibility can be enhanced by other capabilities described herein, to open innovative and additional revenue streams for the participating cellular carriers.

According to various embodiments, as noted above, Cellular Notebook 100 can be configured without any embedded hard disk, CD ROM reader, BLU-RAY™ reader, DVD player, or other drive-based mass-storage device, and so in such embodiments those storage devices can not be used to load programs or data. As a security and stability of operations feature, Cellular Notebook 100 can, in various embodiments, load, add, or access programs, media, or other resources via Web-based downloads from the cellular carrier. In some embodiments, some cellular carriers can enable users to also install additional programs via devices connected to USB port 121 or other integrated connectivity. In such cases, the programs or resources that are retrieved can be loaded into Flash Memory 400, and not program memory 300. One aspect of this distinction is that, should there be a need to reset Cellular Notebook 100, such programs or resources would be erased from Flash Memory 400. In other words, the security of Cellular Notebook 100 can be enhanced by preventing the user (or, by extension, a virus or other rogue process) from modifying program memory 300. In some embodiments, other security measures can be employed.

The initialization processes for Cellular Notebook 100 described above can include a process for capturing the fingerprint of the primary user. In various embodiments, it is desirable that secondary users can be authorized to use Cellular Notebook 100, under control of the primary user. This lower-level authorization for access by secondary users can follow the general flow of a local service, and can be one of the options of the settings page. In various embodiments, the identity of the primary user can first be validated via the use of biometric security user interface 102 and then the secondary user can likewise be requested to use biometric security user interface 102. In some embodiments, biometric security user interface can comprise a fingerprint scanner. Once the image of the fingerprint is captured by the fingerprint scanner, the image for the secondary user can be stored in an encrypted format in a protected area of Flash Memory 400. According to various embodiments, the association of the fingerprint image with the identity and password of the secondary user can be tracked by a Password Manager, such as ROBOFORM™, which can be embedded in program memory 300. This process provides a secure method by which the primary user can control the usage of Cellular Notebook 100 by one or more secondary users. According to various embodiments, the primary user can set different levels of access to services, media, or channels for particular secondary users. For example, a parent may choose to allow a minor child to use cell phone module 1100 for voice communications and HD Radio module 900, but not the Web-based services or SMS messages.

According to various embodiments of Cellular Notebook 100 in a further regard, Cellular Notebook 100 can incorporate an internal software feature, which can be stored in program memory 300 of Cellular Notebook 100, which records, on a continuous basis, connection parameters including, for example, the network connection method and bandwidth speed of the device. According to various embodiments, these network data capture logs can be captured as a textual data batch log file, or other file system. In some embodiments, this log file can be automatically uploaded to the cellular carrier without user intervention. The batch log file can contain IP address, time and date stamps, bandwidth consumed upstream and downstream, and other parameters. This captured usage data can provide heretofore unavailable business intelligence to the cellular carrier. In this way, the present teachings can provide business intelligence insight previously unavailable across the cellular carrier network, as it offers information on third party connection status (e.g., WiFi, WiMax, BLUETOOTH®, HD RADIO, or others) outside of the cellular carrier service provider network. This network intelligence can indicate to a cellular carrier or other access provider the proportion of time a user chooses to access the Web or other portals or resources via the cellular access point, versus a public WiFi, WiMax, or other network. In various embodiments, utilizing date and time stamp row level recording, the cellular carrier can ascertain the device user's specific connection to the Internet and broadcast radio use, beyond the network-centric billing capability of current cellular platforms.

Other embodiments of the present teachings will be apparent to those skilled in the art from consideration of the present specification and practice of the present teachings. Resources described as singular can, in various embodiments, be implemented as distributed resources or as multiple resources, and resources described as multiple or distributed can, in various embodiments, be combined. It is intended that the present specification and examples be considered as exemplary only.

What is claimed is:

1. A mobile wireless communications device, comprising:
a telephony keypad, communicating with a cellular communications module that accesses a wireless cellular channel;
a wireless data module configured to access a wireless data network channel;
a central processing unit (CPU);
a user interface, comprising at least a keyboard, a pointing device, and a display screen, each in communication with the CPU, wherein the user interface is configured to communicate with the cellular communications module and the wireless data module; and
a biometric security user interface configured to authenticate a user to automatically access information or media services alternatively via the wireless cellular channel or wireless data network channel.

2. The mobile wireless communications device of claim 1, further comprising an HD Radio module configured to broadcast at least one of AM radio frequencies, FM radio frequencies, and HD radio frequencies.

3. The mobile wireless communications device of claim 1, further comprising a close range wireless module that can be configured to allow communication between the mobile wireless communications device and a wireless headset.

4. The mobile wireless communications device of claim 1, further comprising a WiFi module configured to enable broadband communication between the mobile wireless communications device and an Internet.

5. The mobile wireless communications device of claim 1, further comprising a Global Positioning System (GPS) module configured to enable location of the mobile wireless communications device.

6. The mobile wireless communications device of claim 1, further comprising a satellite chip configured to receive satellite radio frequencies.

7. A mobile wireless communications device, comprising:
a telephony keypad in communication with a cellular communications module configured to access a wireless cellular channel;
a wireless data module configured to access a wireless data network channel;
a central processing unit (CPU); and
a user interface, comprising at least a QWERTY keyboard, a pointing device, and a display screen, each in communication with the CPU, wherein the user interface is configured to communicate with the cellular communications module and the wireless data module.

8. The mobile wireless communications device of claim 7, further comprising an HD Radio module configured to broadcast at least one of AM radio frequencies, FM radio frequencies, and HD radio frequencies.

9. The mobile wireless communications device of claim 7, further comprising a close range wireless module that can be configured to allow communication between the mobile wireless communications device and a wireless headset.

10. The mobile wireless communications device of claim 7, further comprising a WiFi module configured to enable broadband communication between the mobile wireless communications device and an Internet.

11. The mobile wireless communications device of claim 7, further comprising a Global Positioning System (GPS) module configured to enable location of the mobile wireless communications device.

12. The mobile wireless communications device of claim 7, further comprising a satellite chip configured to receive satellite radio frequencies.

13. A mobile wireless communications device, comprising:
a telephony keypad in communication with a cellular communications module configured to access a wireless cellular channel;
a wireless data module configured to access a wireless data network channel;
a central processing unit (CPU);
a user interface, comprising at least a QWERTY keyboard, a pointing device, and a display screen, each in communication with the CPU, wherein the user interface is configured to communicate with the cellular communications module and the wireless data module; and
a biometric security user interface configured to authenticate a user to automatically access information or media services alternatively via the wireless cellular channel or wireless data network channel.

14. The mobile wireless communications device of claim 13, further comprising an HD Radio module configured to broadcast at least one of AM radio frequencies, FM radio frequencies, and HD radio frequencies.

15. The mobile wireless communications device of claim 13, further comprising a close range wireless module that can be configured to allow communication between the mobile wireless communications device and a wireless headset.

16. The mobile wireless communications device of claim 13, further comprising a WiFi module configured to enable broadband communication between the mobile wireless communications device and an Internet.

17. The mobile wireless communications device of claim 13, further comprising a Global Positioning System (GPS) module configured to enable location of the mobile wireless communications device.

18. The mobile wireless communications device of claim 13, further comprising a satellite chip configured to receive satellite radio frequencies.

19. The mobile wireless communications device of claim 13, further comprising a web camera.
